(19) United States
(12) Patent Application Publication
(10) Pub. No.: US 2004/0256418 A1
(43) Pub. Date: Dec. 23, 2004

(54) Axially actuated valve for dispensing pressurized product

(76) Inventor: Christian T. Scheindel, Randolph Center, VT (US)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/882,625

(22) Filed: Jun. 30, 2004

Related U.S. Application Data
(63) Continuation-in-part of application No. 10/816,969, filed on Apr. 2, 2004, now abandoned.
Application No. 10/816,969 is a continuation of application No. 10/285,238, filed on Oct. 31, 2002, now abandoned.

(51) Int. Cl. G01F 11/30

(52) U.S. Cl. 222/402.15; 222/402.1

(57) ABSTRACT

An axially actuated valve assembly for use in a pressurized container that is easily actuated and controlled by a user to dispense the amount of product desired. The valve stem is moved in an up and down direction so that when dispensing, the user can control amount of the valve openings that are in communication with the material to be dispensed. The flexible boot surrounds the valve stem by having an upper edge that engages the valve actuating ledge and a lower edge that engages the button when in the non-dispensing state. The boot has a squared off lower interior edge engaging the stem and the button of the valve member when in the non-dispensing state. The button of valve is small in diameter and less than the surface of the boot that the button engages. The boot has a substantially straight thin wall neck below the upper edge. Two slits in the neck reduce hoop strength to facilitate outward bowing of the mark when the valve is depressed. The upper edge extends radially inward of the thin wall neck sufficiently to further assure outward bowing of the thin wall as the valve is depressed into the dispensing state.

### REFERENCE TO RELATED APPLICATIONS

This application is a continuation-in-part of Ser. No. 10/816,969 filed 2 Apr. 2004, which in turn is a continuation of Ser. No. 10/285,238 filed 31 Oct. 2002, the entire disclosure of which are hereby incorporated by reference.

### BACKGROUND OF THE INVENTION

This invention relates to an improved valve to be used for a pressurized container and more particularly to a valve for use in a pressurized container that is easily actuated and controlled by a user to dispense the amount of product desired.

Hand held pressurized dispensing containers having a tilt action valve assembly have been known for a long time. Applicant's U.S. Pat. No. 5,785,301 and No. 6,425,503 are representative of prior art valve designs for use in these pressurized dispensing containers. When the valve is tilted, at least one full opening is exposed to the contents of the container. The contents, under pressure from a piston or a bag in a pressurized container, will be dispensed through the openings in the valve stem.

The above references teach a number of tilt valves for hand-held pressurized dispensing containers. A principle problem with the tilt valve for dispensing pressurized product is that it is hard for the user to control the amount of product dispensed. Further, the tilt valve does not allow the user to keep the valve partially open or partially closed. The tilt valve only allows the user to either fully open or fully close the valve.

It has been found that axially actuated valves also known as up/down valves can be actuated by a lever which permits the user to control the valve so that the product flow can be determined by the user. Also, the axially actuated valve readily allows the user to consistently keep the valve partially open or partially closed for a period of time. Applicant's U.S. Pat. No. 6,340,103 illustrates an axially movable valve.

A major purpose of this invention is to provide an axially movable valve with sufficiently low restoring force, so that the force required by the user to open the valve is minimized.

A related purpose of this invention is to provide a design in which this minimized opening force is low enough so that a simple plastic handle structure can be used as the actuating lever for opening the valve.

A further purpose of this invention is to provide a valve design for pressurized dispensing containers that allows the user to easily control the amount of product dispensed.

A further object of this invention is to obtain the above objects in a design which provides a low cost valve, so that adoption of the invention for its enhanced dispensing performance will be a cost effective choice for the user.

### BRIEF DESCRIPTION

In brief, the improved pressurized dispensing container valve disclosed herein has an axially actuated valve assembly design that minimizes the force necessary to open the valve in a vertical direction from its sealing state to its dispensing state for dispensing product.

The axially actuated valve assembly comprises an axially moveable valve and an annular flexible boot. The axially movable valve has a stem with a wall defining a main passageway having an axis. The valve has an actuating flange extending radially out from an intermediate portion of the stem and has a button at the base of the stem with dispensing openings through the wall of the valve stem at the base of the valve stem. The valve has a normal sealing state and a dispensing state.

The annular sealing boot surrounding the valve stem has an upper edge that engages the valve actuating flange and a lower edge that engages the button. The boot has a squared off lower interior edge that engages the stem and the button of the valve when in the sealing state. The boot also has a straight thin wall neck below the upper edge. The upper edge extends radially inward of the thin wall neck sufficiently to assist in the outward bowing of the thin wall as the valve member is depressed when moved from the sealing state to the dispensing state. The boot further has a slit or opening in the thin wall neck to minimize hoop strength resistance to facilitate the outward bowing of the thin wall in this section when the valve member is depressed to dispense product. The boot neck design collapses or gives fairly easily to the vertical actuating force for dispensing product.

### BRIEF DESCRIPTION OF THE FIGURES

FIG. 1 is an elevation view in partial longitudinal section of an embodiment of a valve assembly mounted on a pressurized container 12. FIG. 1 shows a dispensing lever 16. The valve assembly, as shown in FIG. 3, includes the annular resilient sealing boot 20 as well as the valve 18. FIG. 1 shows the valve assembly in the axially up, normal sealing state.

FIG. 2 is a view similar to that of FIG. 1 except that the valve assembly is axially depressed into its dispensing state.

FIG. 3 is a view similar to that of FIG. 1 except that the nozzle 14 is screwed down on the threaded valve 18 to the point where the lever 16 cannot be actuated. This is the position in which the container is usually shipped and stored.

FIG. 4 is a view in partial elevation and partial section showing primarily the valve assembly which constitutes the valve 18 and resilient sealing boot 20. FIG. 3 shows the mounting of the boot 20 to the top of the pressurized container. The lever actuator shown in FIGS. 1 and 2 is not shown in FIG. 4. FIG. 4 shows the valve assembly in the axially up, normal sealing state.

FIG. 5 is a view similar to that of FIG. 4 except that the valve assembly 18, 20 is axially depressed into its dispensing state.

FIG. 6 is a longitudinal-sectional view of the boot or sealing element 20 in the normal sealing state position.

FIG. 7 is a view similar to that of FIG. 6 except that it shows the sealing boot 20 in the compressed dispensing state in which the neck 38 and slit 40 are compressed.

FIGS. 8A, 8B and 8C are views of the plastic manually actuated lever 16 used to depress the valve assembly for dispensing product. FIG. 8A is a side view. FIG. 8B is a bottom view and FIG. 8C is an end view.

FIGS. 9A, 9B and 9C are views of the plastic base 21 on which the lever 16 is mounted and which in turn is mounted to the top of the container 12. FIG. 9A is a top view. FIG. 9B is a side view. FIG. 9C is a bottom view.

FIG. 10 is a view showing the rotatable engagement between the lever 16 and base 21.

### DETAILED DESCRIPTION

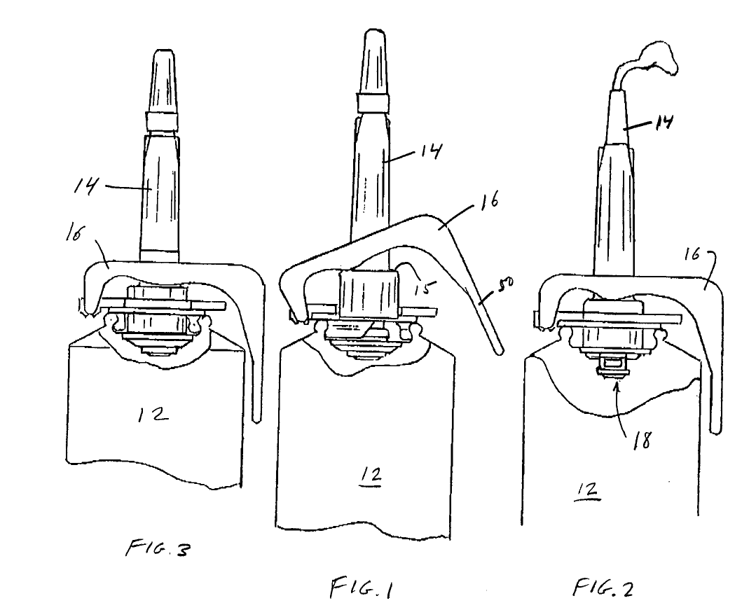

FIGS. 1 through 3 show a valve assembly mounted on a container 12. The product in the container 12 is maintained under pressure, typically by a pressurized piston or pressurized bag (not shown). When the valve assembly is depressed, material is dispensed from the container through the valve assembly and a nozzle 14. An actuating lever 16 permits manual depression of the valve assembly.

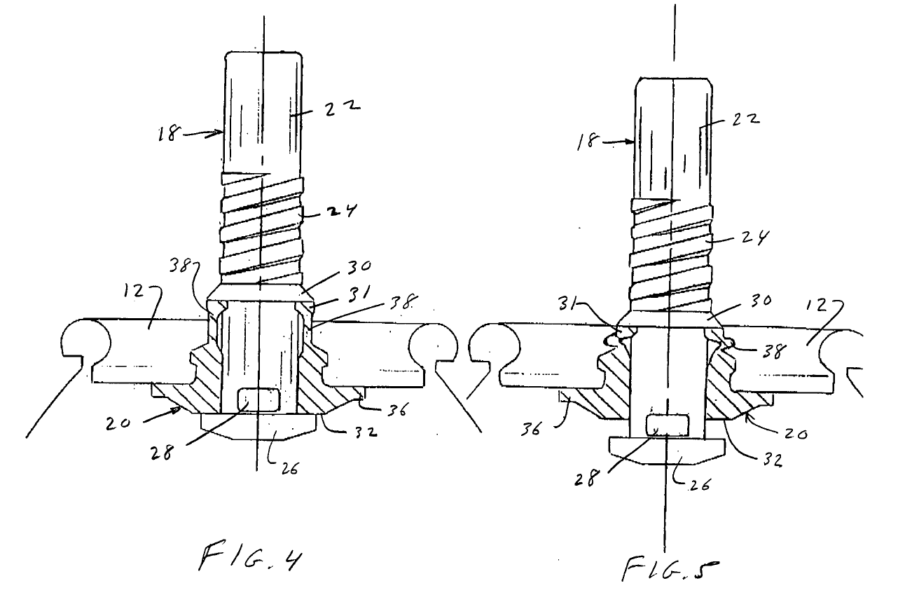

As best seen in FIGS. 4 and 5, the valve assembly includes two primary separate components. They are: a substantially annular valve 18 and an annular flexible sealing boot 20. As shown in FIGS. 1 and 2, the lever 16 is positioned to engage a flange 15 on the nozzle 14, which nozzle in turn engages the valve 18 to move the valve assembly from its FIG. 1/FIG. 3 sealing state to its FIG. 2/FIG. 5 dispensing state.

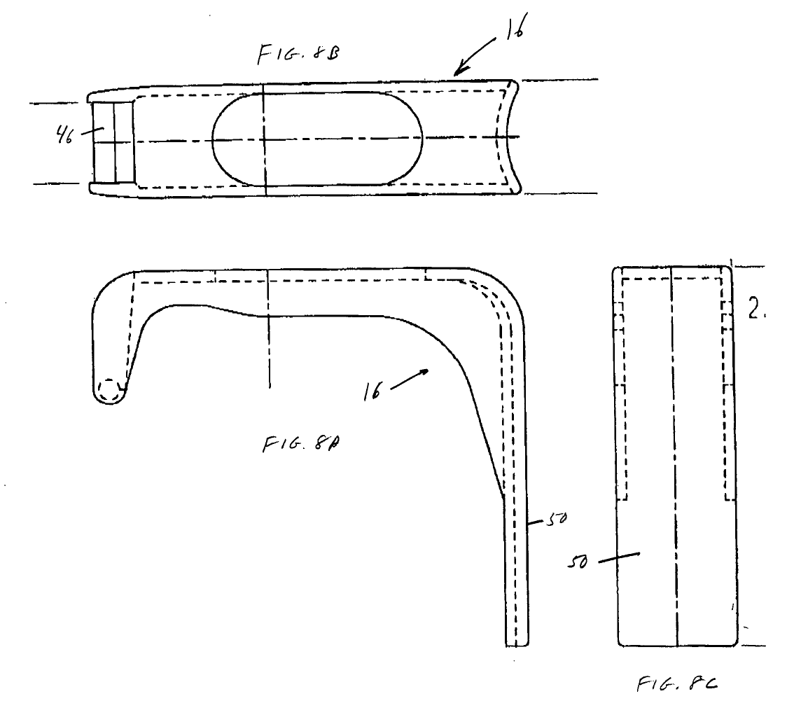

The lever 16 is mounted on a base 21 for rotation about a pivoting element 46 (see FIG. 8B). The base 21 is mounted on the top of the container 12.

FIGS. 4 and 5 show the valve assembly 18, 20 in detail. The valve stem 22 has threads 24 which engage internal threads (not shown) on the nozzle 14.

The threaded relation permits adjusting the nozzle 14 and valve element 18 so that the amount by which the lever 16 can depress the nozzle 14 and valve 18 can be limited to between a full operable state, when the nozzle 14 is threaded up, to a storage, no movement state when the nozzle 14 is threaded down. That is, when the nozzle 14 is threaded down, the valve 18 is in its closed state and the lever 16 is positioned as shown in FIG. 3 and no product can be dispensed. When the nozzle 14 is threaded up to either the FIG. 1 position or to an intermediate position, the lever can be manually actuated to dispense product.

The lower end of the valve 18 has a button 26 and stem sidewall openings 28. A longitudinal passageway in the stem 22 is in communication with the sidewall opening 28 so that material in the container under pressure will be dispensed through the sidewall openings 28 and the stem passageway into a nozzle. There are two openings 28 in the embodiment shown.

The valve stem 22 has a ledge 30 that extends radially out from an intermediate portion of the stem 22 and engages the top 31 of the boot 20.

The resilient boot 20 normally holds the valve 18, and any nozzle 14 which engages the valve 18, in the FIG. 1/FIG. 4 position. This is a non-dispensing sealing position. In the FIG. 1/FIG. 4 position, the valve stem openings 28 are not in communication with the interior of the container 12 because the resilient boot 20 blocks the openings 28.

The flexible resilient boot 20 surrounds the valve stem 22. The upper edge 31 of the boot engages the valve ledge 30. The lower surface 32 of the boot 20 engages the button 26 in the FIG. 4 sealing state. The lower surface 32 and annular inner surface 34 of the boot 20 are orthogonal. This provides that in the sealing state, (a) the boot 20 engages the stem 22 to the bottom of the stem and (b) the button 26 engages the lower surface 32 of the boot over the entire exposed upper surface of the button 26.

The resilient boot 20 has a flange 36 which engages the inner surface of the cap of the container 12. In the non-dispensing state, the valve stem openings 28 are within the boot 20 and thus sealed from the contents of the container.

When the valve 18 is depressed through actuation of the lever 16, the thin straight segment or neck 38 of the boot flexes permitting the valve 18 to move down into the container sufficiently so that the openings 28 are in communication with the material to be dispensed from within the container 12.

In one embodiment, the thickness of the straight thin neck segment 38 is 27 mils (0.027 inches).

It is preferred to keep the diameter of the valve button 26 as small as possible to minimize the force required to move the valve against the pressure of the contents within the container. In one embodiment, the valve button 26 has a diameter of 460 mils (0.460 inches) while the valve stem 22 has an outer diameter of 350 mils (0.350 inches).

In that embodiment, the lower surface 32 of the boot 20 has a diameter of 550 mils (0.550 inches) and thus is greater than the button 26 upper surface diameter.

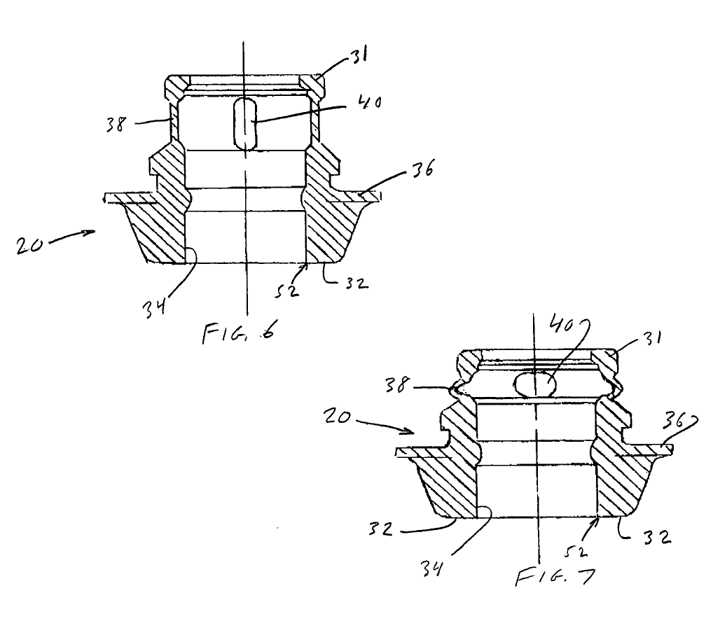

FIGS. 6 and 7 are a vertical-sectional view through the boot 20 showing the thin neck segment 38 which facilitates compression of the boot 20 when the valve 18 is moved from its sealing non-dispensing state to its dispensing state. The boot 20 in its sealing state is shown in FIG. 6 while the dispensing state of the boot is shown in FIG. 7. Slits 40 are openings in the neck 38 that facilitates compression of the neck 38 by relieving circumerential or hoop forces. There are two slits 40 in the neck spaced 180° from one another. The purpose of the slits 40 is to further assure an outward bowing of the thin neck segment 35.

A small retaining wall of about forty mils in height between the bottom edge of each valve opening 28 and the valve button 26 serves to assure that the resilient and flexible material of the boot 20 does not extrude into the openings 28 when under the internal container pressure during the non-dispensing sealing state.

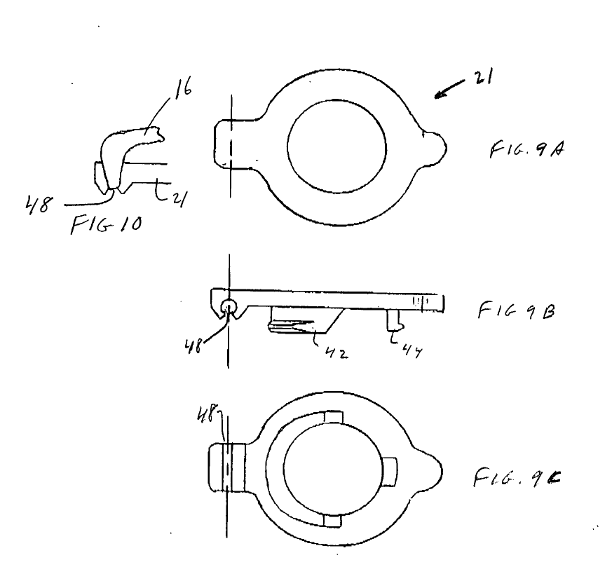

The plastic lever 16 and plastic base 21 is shown respectively in FIGS. 8A through 8C and 9A through 9C. The pivoting engagement between the lever 16 and base 21 is shown in FIG. 10. The manner in which the base 21 mounts on the top of the container 12 is described in U.S. Pat. No. 6,340,103 and thus need not be described any further except to point out that the engagement elements 42 and 44 on the base engage the rim of the container 25 to position the base 21 firmly on the container.

The forward portion of the lever 16 has a tubular pivoting element 46 which snaps onto the opening 48 of the base so that the lever 16 can be pivoted relative to the base 21. The handle portion 50 of the lever 16 is in the vertical position as shown in FIG. 3 during storage and shipment when the nozzle is screwed down on the valve so that it cannot be actuated. When the nozzle is screwed up on the valve to prepare for dispensing product, the lever 16 is in the FIG. 1 position and the handle 50 is at an angle as shown. When dispensing product, the handle can be brought down as far as the vertical position shown in FIG. 2 or to any intermediate position that the user wishes so as to control the amount of product dispensed.

The diameter of the button 26 is less than the diameter of the boot base 32. This relationship, together with other aspects of the boot design such as the squared off internal corner 52, aids in assuring that the valve 18 will travel in an axial direction and will not tend to tilt. In one embodiment, the diameter of the boot base 32 is approximately 550 mils, the diameter of the button 26 is approximately 460 mils, and the outer diameter of the stem is 350 mils.

In that embodiment, the thin neck segment 38 has an inner diameter of approximately 380 mils and is outwardly recessed on a radius by about 15 mils from the primary inner surface of the boot. This provides a small space of about 15 mils on a radius between the boot neck 38 and the valve stem 22. This dimensional relationship helps to assure that when compressive forces are applied by the ledge 30 during the opening of the valve that the thin neck segment 38 tends to bulge outwardly. That is because the axial force on the neck will tend to be toward the inner surface of the neck. In that embodiment, the slit or opening 40 is 160 mils long and 100 mils wide.

There are a number of interrelated valve assembly features which make possible the ready actuation of the valve in an axial direction and also assures that the valve will not tilt during actuation. The features which provide these results include:

(a) The squared off interior corner 52 at the base 32 of the boot 20 assures that the stem and boot will engage down to the button 26.

(b) The fact that the button 26 diameter is less than the diameter of the base 32 of the boot.

(c) The thinness of the neck 38 facilitates collapse of the neck when moving from the sealing state to the dispensing state.

(d) The slits 40 in the neck 38 reduce hoop strength and thus reduce resistance to outward bowing of the neck, and

(e) The outward recess of the inner surface of the neck 38 from the valve stem resolves axial compressive forces in a way that tends to aid in the outward bowing of the neck.

The valve of this invention, specifically a valve that has an up-down movement, provides the user the ability to easily control the flow rate of the product and the amount of product dispensed. The valve design of this invention allows the user to partially open or close the valve to control the flow rate of the product. This is unlike the tilt valve with only allows the valve to be either fully opened or fully closed.

This valve design is useful for dispensing at a continuous rate the amount of product needed with the use of a lever.

Use and control over the flow rate is provided by the fact that the extent to which the user depresses the valve will affect the amount of the valve opening and thus the flow rate.

While the foregoing description and drawings represent the presently preferred embodiments of the invention, it should be understood that those skilled in the art will be able to make changes and modifications to those embodiments without departing from the teachings of the invention and the scope of the claims.

What is claimed is:

1. In a pressurized dispensing container having an axially actuated valve assembly having a sealing state and a dispensing state, the valve assembly including a valve member having a stem with a dispensing opening and a button at the lower end of the stem and also having a resilient annular sealing boot around the stem to bias the stem into a sealing state, the boot extending between a ledge on an intermediate portion of the stem and the boot, the improvement comprising:
said boot having an annular interior surface and a lower surface, said surfaces having a substantially orthogonal relationship to assure engagement between the boot and the valve stem down to the button surface when in the sealing state, and
said boot having an upper edge for engaging the ledge of the stem and a thin wall annular neck segment below said upper edge,
whereby the orthogonal relationship between said surfaces provides a resistance to tilting and said thin wall section minimizes resistance to axially downward movement.

2. The improvement of claim 1 wherein:
said button is a small diameter button having a diameter less than that of said base of the boot,
whereby the small size of the button minimizes resistance to downward axial movement and the engagement of the outer edge of the button with said lower surface of the boot provides resistance to tilting.

3. The improvement of claim 1 further comprising:
openings in said thin wall neck segment to reduce hoop strength and to facilitate outward bowing of said thin wall segment when the valve is depressed into its dispensing state.

4. The improvement of claim 2 further comprising:
openings in said thin wall neck segment to reduce hoop strength and to facilitate outward bowing of said thin wall segment when the valve is depressed into its dispensing state.

5. The improvement of claim 1 wherein: said thin wall neck has a substantially constant diameter inner surface and said upper edge of the boot extends inboard of said inner surface to assure outward bowing of said neck when the valve is compressed into its dispensing state.

6. The improvement of claim 2 wherein: said thin wall neck has a substantially constant diameter inner surface and said upper edge of the boot extends inboard of said inner surface to assure outward bowing of said neck when the valve is compressed into its dispensing state.

7. The improvement of claim 3 wherein: said thin wall neck has a substantially constant diameter inner surface and said upper edge of the boot extends inboard of said inner surface to assure outward bowing of said neck when the valve is compressed into its dispensing state.

8. The improvement of claim 4 wherein: said thin wall neck has a substantially constant diameter inner surface and said upper edge of the boot extends inboard of said inner surface to assure outward bowing of said neck when the valve is compressed into its dispensing state.
